(19) United States
(12) Patent Application Publication
(10) Pub. No.: US 2008/0275291 A1
(43) Pub. Date: Nov. 6, 2008

(54) Acceleration Protection Suit

(75) Inventor: Andreas Reinhard, Zurich (CH)

Correspondence Address: WINSTEAD PC, P.O. BOX 50784, DALLAS, TX, 75201, US

(73) Assignee: Yamanashi University, Yamanashi (JP)

(21) Appl. No.: 11/628,791

(22) PCT Filed: Jun. 13, 2005
(86) PCT No.: PCT/CH2005/000329

§ 371 Date: Nov. 20, 2007

(30) Foreign Application Priority Data
Jun. 18, 2004 (CH) 1032/04

(51) Int. Cl. A41D 13/00; B64D 10/00

(52) U.S. Cl. 600/20; 2/455

(57) ABSTRACT

An acceleration protection suit having a sparingly extensible outer layer with veins running essentially along a bodily axis of a wearer which deforms when pressurized in such a way as to generate a tension in the sparingly extensible outer layer, with which pressure can be exerted on the wearer to offset G-forces. Means are provided for tightening and adjusting the protective suit to the wearer. At least part of the veins are permeable to gas at least in spots on a side facing the wearer so that the wearer can be air-conditioned by exiting gas when the veins are pressurized.

### BACKGROUND OF THE INVENTION

1. Technical Field

This invention relates to an acceleration protection suit.

2. History of Related Art

Acceleration protection suits are basically known, and as a rule are operate based on the hydrostatic lift principle or pressurized with compressed air. In both instances, an outside pressure is built up in this way, acts on the carrier, and compensates for the hydrostatic pressures in the body of the carrier brought about by the acceleration forces.

This invention is made most obvious by EP 99 913 056 (D1). The G-suit disclosed in D1 essentially consists of a textile with limited extensibility, into which run veins that can be pressurized with air. The pressurization changes the cross section of the veins in such a way that the textile with limited extensibility is tensioned around the body, thereby exerting an outside pressure against the carrier that is elevated by comparison to the ambient pressure.

While tensioning the G-suit may offset G-forces acting on the carrier, it results in the G-suit fitting extremely tightly at this moment. Since the wearer is exposed to the G-forces on the one hand and by the G-suit on the other, he at least physically finds himself in a situation of stress. A stressed body tends to heat up and perspire. The tightly fitting G-suit further enhances this effect. Neither the additional warmth nor the moisture can be dissipated, creating an uncomfortable heat problem for the wearer.

### SUMMARY OF THE INVENTION

The object of this invention is to disclose an acceleration protection suit with an elevated wearing comfort, which avoids the heat problem at the moment G-forces arise.

The object is achieved as described in the characterizing clause of the independent claim by its essential features, and in the dependent claims by its additional advantageous features.

The acceleration protection suit, hereinafter referred to as G-suit, consists to a significant extent of a sparingly extensible material, which is located in an outer layer and an inner layer. At least the outer layer tightly covers basically the entire body of the wearer, except for the head, hands and feet. The inner and outer layers are interconnected in such a way as to produce veins. The veins are at least partially permeable to gas on the side facing the wearer, or gas-permeable ducts are inlaid therein in the same way. The G-suit is tailored in such a way as to tightly fit the wearer, meaning that the veins are flat. If the veins, or the ducts, are pressurized, a roughly oval or almost round cross section is imparted to the veins on the one hand. The deformation of the veins causes the diameter to decrease transversely to their lengthwise expansion. Since at least the outer layer of the G-suit is sparingly extensible, and the G-suit already fits the body snugly, it visibly tensions as the vein diameter decreases. The wearer perceives the tension in the G-suit as a pressure working from outside. This pressure can be used to offset the hydrostatic pressure in the blood vessels of the wearer caused by exposure to G-forces. On the other hand, air or another compressed gas begins to stream out of the gas-permeable parts of the veins or ducts. This air stream can be used to air condition the wearer. Both effects, the compensation of G-forces and air conditioning of the body, hence take place essentially at the same time. This yields a system that not only protects the body, but also provides air conditioning for the body in this situation of stress, most often taking the form of cooling. Because the increasing stresses in the G-suit are accompanied by an increasing pressure in the ducts, the air conditioning effect is simultaneously enhanced, since more air is also dissipated through the gas-permeable parts of the veins or ducts at an elevated pressure.

### BRIEF DESCRIPTION OF THE DRAWINGS

A more complete understanding of the G-suit of the present invention may be obtained by reference to the following Detailed Description, when taken in conjunction with the accompanying Drawings, wherein:

FIGS. 1a-1b illustrate a diagrammatic cross section through a vein of a first exemplary embodiment, starting position;

FIG. 2 illustrates a diagrammatic cross section through a vein of a second exemplary embodiment, operating position;

FIGS. 3a-3c illustrate a diagrammatic cross section through a vein of a third exemplary embodiment;

FIG. 4 illustrates a diagrammatic cross section through a vein of a fourth exemplary embodiment;

FIG. 5 illustrates a diagrammatic cross section through a vein of a fifth exemplary embodiment;

FIG. 6 illustrates a diagrammatic cross section through a duct;

FIGS. 7 and 8 illustrate two first embodiments of holes in a duct, diagrammatic views;

FIGS. 9a-9b illustrate a second embodiment of holes in a duct, diagrammatic views; and

FIG. 10 illustrates a G-suit with veins, diagrammatic view.

### DETAILED DESCRIPTION OF THE DRAWINGS

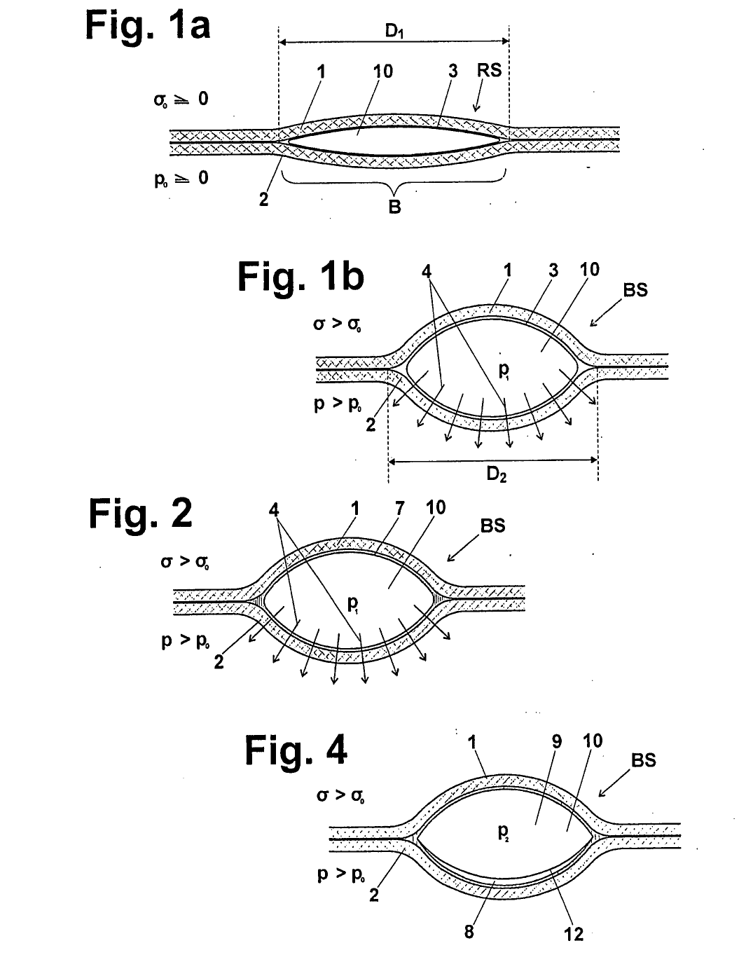

FIGS. 1a and 1b show a cross section through a vein 10 of a G-suit 15. The vein 10 is formed by an area B of the outer and inner layers 1, 2. The layers 1, 2 are not interconnected in this area B. The layers 1, 2 are tightly interconnected at least to the left and right of this area. This can be accomplished through adhesion, sewing or welding, for example. The layers 1, 2 consist of a sparingly extensible material, for example, aramide-fiber reinforced textile. The vein 10 formed in area 10 has an inlaid duct 3. FIG. 1a shows the vein 10 with its duct 3 in a starting position RS. The vein 10 has a diameter of D1 in the starting position RS. The vein 10, and hence the duct 3, are essentially flat, and no air circulates. However, the G-suit 15 already fits snugly against the body in its starting position RS, so that a prestress σ₀≧0 is already present, at least in the sparingly extensible layer 1. The prestress σ₀ roughly corresponds to a tension that can be generated by closing zippers or Velcro snaps, and can be used to smooth out folds in the G-suit 15. The wearer of the G-suit 15 perceive this stress σ₀ as pressure p₀≧0. FIG. 1b shows a vein 10 in the operating position BS. The duct 3 is pressurized with pressure p₁, and has assumed an essentially oval cross section. The change in cross section of the duct 3 is imparted to vein 10, causing the latter to thicken, and its diameter to decrease transversely to the longitudinal orientation, so that it now has a diameter D₂ wherein D₂<D₁. This increases the stress σ in the layer 1 to σ>σ₀. Accordingly, the wearer perceives an outside pressure generated by the G-suit 15 measuring p≧P₀. The outside pressure p can also be used to offset hydrostatic pressures in the blood vessels of the circulatory system caused by acceleration forces. Pressurizing the ducts 3 with pressure p₁ also causes the air to circulate through the gas-permeable parts, openings 4 or slits 11, in the ducts 3, air conditioning the wearer. As the pressure p₁ in the ducts 3 increases, the circulation in the ducts 3 is also increased, thereby providing air conditioning to the wearer. To overcome a load, the stressed body reacts with an elevated pulse, and hence increased heat production and transpiration. Coupling the pressure p₁ to the tension σ according to the invention on the one hand, and hence to the outside pressure p perceived by the wearer, and to the air conditioning of the wearer on the other results in a protection system in which it is enough to control a single parameter, pressure p₁, in order to offset the hydrostatic pressure and dissipate the additional body heat.

Instead of the duct 3, the second embodiment of the vein 10 shown on FIG. 2 has a gastight coating 7 on its inside. Openings 4 are introduced in the coating 7, e.g., through embossing or stamping, through which the air can circulate while pressurizing the veins 10.

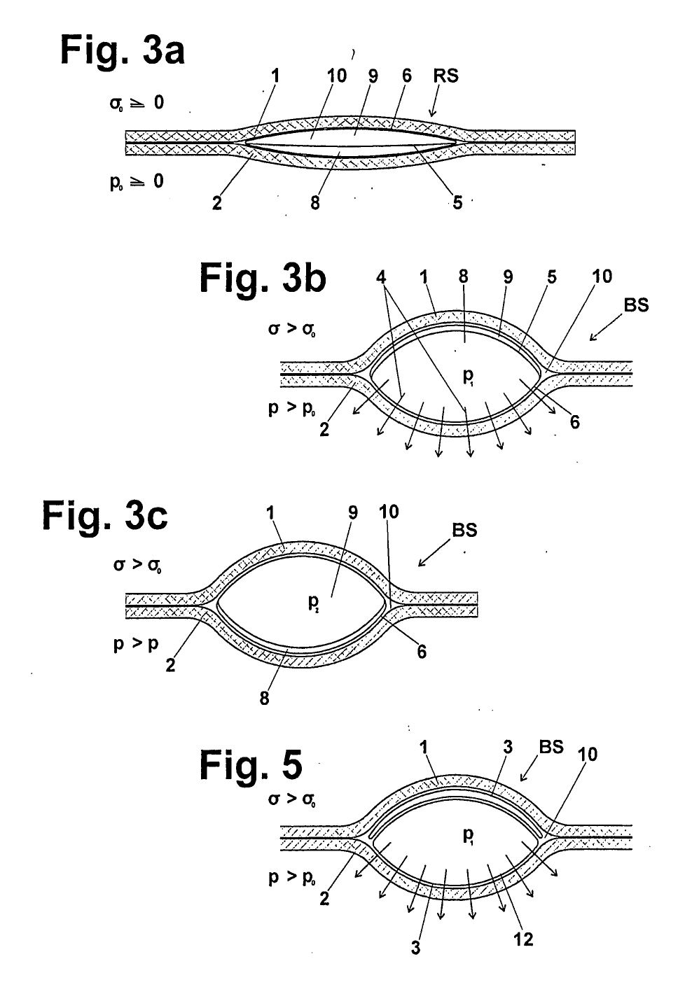

FIGS. 3a to 3c show a second embodiment of the G-suit 15 according to the invention. The ducts 6 arranged in the veins 10 have an inner separating wall 5, which runs in the longitudinal expansion of the ducts 6, and divides the interior of the ducts into two chambers 8, 9. In terms of function, the first chamber 8 corresponds to the duct 3 in the first exemplary embodiment on FIGS. 1a, 1b. The first chamber 8 lies on the side of the separating wall 5 facing the body, and is at least partially permeable to gas toward the body. When pressurized with a pressure p₁, the first chamber deforms, or the layers 1, 2 expand, and the wearer perceives an outside pressure p. The wearer is also fanned and air-conditioned through the gas-permeable parts of the first chamber 8.

Altitude protection is realized with the second chambers 9. The second chambers 9 are gastight, and respond given an outside pressure drop, e.g., if the ambient pressure in the cockpit collapses due to damage at a high altitude. The chambers 9 can exert their effect in basically two different ways. In the first case, the chambers 9 are filled with a predetermined quantity of gas, e.g., air, and sealed gastight. This quantity of gas is such that, when the outside pressure is removed, a pressure p₂ acts in the chambers 9, tensioning the G-suit 15 owing to deformation of the chambers 9, and hence the veins 10, so as to exert a pressure p on the wearer that is sufficient to avoid nitrogen and steam bubble formation, along with other altitude sickness symptoms. At a higher outside pressure or a higher pressure p₁ in the first chambers 8, the chambers 9 are compressed. In the second case, the chambers 9 are only filled with a predetermined quantity of gas when a pressure drop is encountered. This quantity of gas is preferably furnished by a separate and independent system, for example by a compressed gas storage tank secured to the wearer or G-suit 15, which releases its gas once the pressure has fallen to below a predefined minimum level. The altitude protection is most effective when used in combination with a pressure respirator system of the kind routinely used in high-performance aircraft today. The exemplary embodiment on FIG. 4 shows a vein 10 with a coating 7, wherein the vein 10 incorporates a membrane 12. The membrane 12 forms two chambers 8, 9 in this embodiment as well. The two chambers 8, 9 operate in the same way as described on FIG. 3a to c. FIG. 4 reflects the state shown on FIG. 3c.

FIG. 5 shows a variant of the exemplary embodiment described on FIGS. 3a to 3c. Two ducts 3 are arranged in a vein 10 in place of the duct 6 with separating wall 5. The first duct 3 acts as the first chamber 8, and is at least partially gas permeable. The second duct 3 acts as the second chamber 9, and is gastight.

Of course, the above embodiments and variants of the G-suit 15 can also be combined into a single G-suit 15.

The altitude protection device described on FIGS. 3 to 5 also operates with a first chamber 8 or first duct 3 if the latter is/are filled with a liquid.

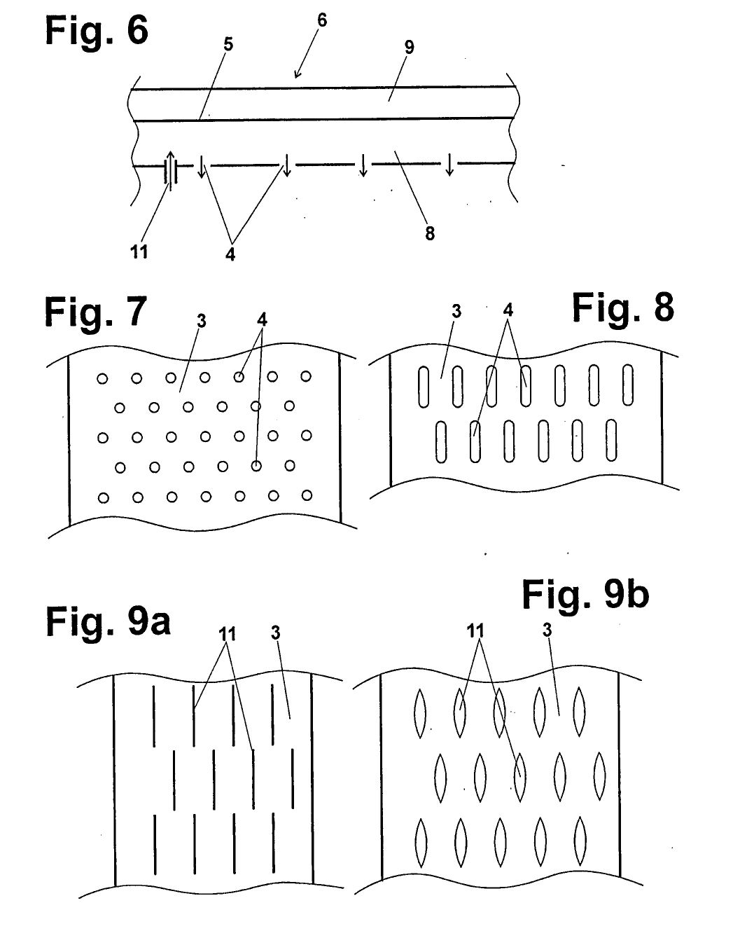

FIG. 6 shows a longitudinal section through a duct 6. The first chamber 8 is situated in the lower area, and the second chamber 9 is situated in the upper area. The first chamber 8 has openings 4 through which the wearer is air-conditioned. The air for pressure buildup and ventilation are provided through an air line 11. Based on the chambers 8, 9, the ducts 3 can be designed to reflect the function to be performed. If the chamber 9 is first filled with air once the outside pressure is omitted, or drops to below a specific threshold, the chambers 9 have their own air line 11.

FIGS. 7 and 8 show body-facing areas of ducts 3, in which openings 4 are present; this also applies analogously to the body-facing side of the first chamber 8 or a vein 10 with a gastight coating 7. Circular and rectangular openings 4 are shown. Of course, other shapes can be used according to the invention. To prevent the pressure from dropping along a duct 3, the openings 4 can become larger with increasing distance from the air line 11, or their number per surface unit can be increased. For example, an arrangement with round openings 4 can be selected in the region of the air line 11. As distance from the air line 11 increases, the openings 4 can be elongated in the longitudinal direction of the duct until reaching a configuration of the kind shown on FIG. 8. The openings 4 need not be regularly distributed, but can also be brought in line with physiological specificities. For example, the frequency of openings 4 can increase toward the middle or edges of the underside of the duct 3. The openings 4 are designed to always be open, even when no air is being forced into the duct 3. If the duct 3 is made out of an extensible material, and its circumference is smaller than the inner circumference of the veins 10, the duct 3 expands when pressurized until it abuts the vein from the inside. As a result, the openings increase in size as a function of pressure p₁ until reaching maximum expansion. If the selected circumference of the duct 3 is roughly the same as the inner circumference of the vein 10, the duct 3 will not expand when pressurized. In particular in this embodiment, the duct 3 can also be made out of a sparingly extensible material.

FIGS. 9a, 9b show a second embodiment of body-facing sides of ducts 3, 6. The openings 4 are here replaced by slits 13 on the underside of the duct 3, 6. The distribution and length of the slits 13 can here reflect that of openings 4. However, an extensible material is required for the duct 3, 6 in this embodiment, and the duct has a smaller circumference as the vein in which it is situated in the unpressurized starting position RS. In the starting position RS, the duct 3, 6 is retracted, and the slits 111 are closed. Only after the duct 3, 6 is pressurized do the slits begin to open, since the duct expands according to the pressure p₁. The expansion is limited by the veins 10. A further pressure increase does not cause the slits 13 to open further, but rather elevate the air flow and air conditioning of the wearer.

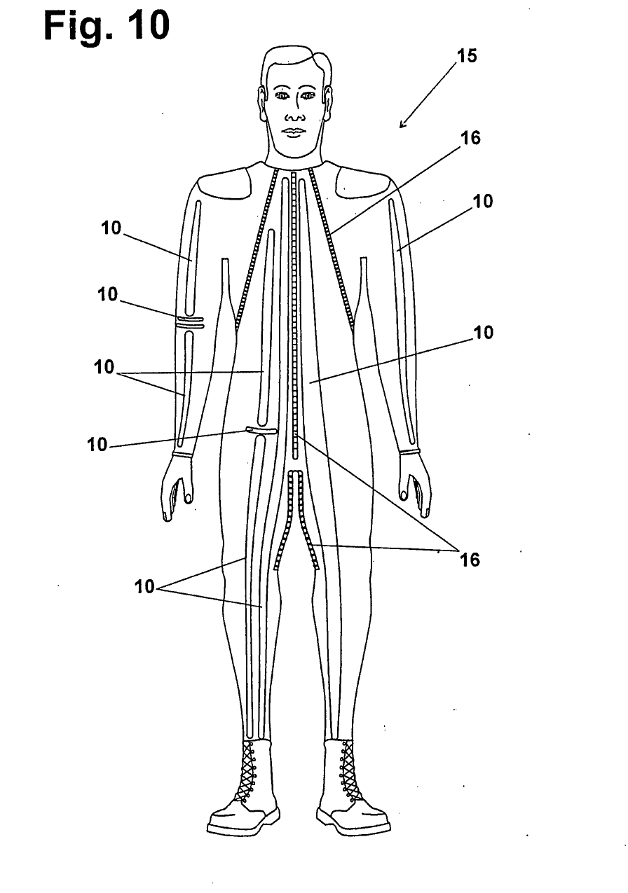

FIG. 10 shows a diagrammatic view of a G-suit 15 according to the invention. In order to generate the prestresses σ₀, it has several zippers 16, for example. Veins 10 are arranged in the G-suit 15 in such a way that they can tension the G-suit 15 distributed essentially over the entire body surface. The veins 10 can be arranged in a variety of ways. For example, they can run in a single piece over the entire length of the G-suit 15, or only over a section. In the case of joints, e.g., elbows and hips, veins 10 can be situated in such a way as to compensate shortenings caused by bending joints. A duct 3, 6 with circumference U has a diameter of D_{RS}=U/2 in its starting position. In the operating position BS, the duct can theoretically assume a round cross section, i.e., a diameter of Dₘᵢₙ=U/π. Given that Dₘᵢₙ/DRS=2/π=0.64, it is clear that the duct diameter shorts to a maximum of about 64% of its diameter D_{RS}, or shortens by a maximum of about 36%. The pressure exerted on the wearer by the G-suit 15 must not be the same all over. For example, the hydrostatic inside pressure in the vascular system of a wearer increases from the head to the feet given changes in direction. Care must also be taken to prevent the G-suit 15 from compressing the lungs of the wearer. Physical scope also varies greatly depending on location. Even though the elasticity of layers 1, 2 is very low, it must be taken into account along with the physical scope. The pressures to be generated locally by the G-suit 15 can be taken into account via the arrangement, number and width of the veins. Not shown on FIG. 10 is the line and valve system for compressed air distribution.

Ducts 3, ducts 6 or two ducts 3 can be arranged in the veins 10 of the G-suit 15. Of course, the different mentioned arrangements and exemplary embodiments can also be combined according to the invention. The invention also allows designing the jacket and pants of the G-suit 15 as separate garment pieces. Also included in the inventive idea is to equip a G-suit 15 according to the invention with shoes. The pneumatic components of such shoes can exert pressure on the feet of a wearer on the one hand, while the feed are aerated on the other.

For example, the ducts 3, 6 arranged in the veins 10 can be permeable to gas over the entire body on their side facing the body, so that the entire body can be air-conditioned. The ducts 3, 6 can also only be permeable to gas in the area of the upper body on the side facing the body, resulting in partial air conditioning. It is further conceivable to pneumatically operate only those ducts 3, 6 that run in areas of the G-suit 15 where the body is to be air-conditioned. For example, ducts 3 can be filled with a liquid in the veins 10 of the arms. Pressure p₁ comes about hydrostatically in these veins 10 for molding the veins 10.

1. A G-suit consisting at least of:
a sparingly extensible outer layer with veins running essentially along a bodily axis of a wearer, which deforms when pressurized in such a way as to generate a tension in the sparingly extensible outer layer, with which pressure can be exerted on the wearer to offset G-forces;
means for tightening and adjusting a protective suit to the wearer; and
wherein at least part of the veins are permeable to gas at least in spots on a side facing the wearer so that the wearer can be air-conditioned by exiting gas when the veins are pressurized.

2. The G-suit according to claim 1, wherein the veins are coated gastight on the inside and have openings in the gas-permeable areas.

3. The G-suit according to claim 1, wherein at least one gastight duct is inlaid in the veins, wherein the veins are, gas permeable at least in spots on the side facing the wearer.

4. The G-suit according to claim 3, wherein a circumference of the at least one gastight duct essentially corresponds to an inner circumference of the veins in which it is incorporated.

5. The G-suit according to claim 3, wherein the circumference of the at least one gastight duct is smaller than the inner circumference of the veins in which it is incorporated, and the at least one gastight duct consists of an extensible material.

6. The G-suit according to claim 5, wherein the at least one gastight duct is provided with slits which open more and more as pressure increases until the at least one gastight duct abuts an interior of the vein and can no longer expand further.

7. The G-suit according to claim 6, wherein the veins or the at least one gastight duct are provided with openings which are always open even when no air is forced into the at least one gastight duct.

8. The G-suit according to claim 7, wherein the openings in the veins or the at least one gastight duct are only present in areas.

9. The G-suit according to claim 7, wherein the openings in the veins or the at least one gastight duct are present all over the side of the veins or the at least one gastight duct facing the wearer.

10. The G-suit according to claim 1, further comprising:
at least a portion of a longitudinal expansion of veins has arranged along it at least a second duct;
a the second duct having a first and a second chamber, wherein the second duct is arranged along its longitudinal expansion, or
if the vein has a coating, it exhibits a gastight membrane, thereby giving rise to the first and second chambers along the longitudinal expansion of the veins; and
wherein the second duct or the second chamber is gastight and lies in the vein on a side facing away from the wearer.

11. The G-suit according to claim 10, wherein the first and second chambers are formed by the second duct with a separating wall running inside along its longitudinal expansion.

12. The G-suit according to claim 10, wherein the second duct or the second chamber is sealed and filled with a predetermined quantity of gas.

13. The G-suit according to claim 10, wherein a gas storage device is present which fills the second duct or the second chamber with a predetermined quantity of gas.

14. The G-suit according to claim 13, wherein given an external pressure drop at a great altitude, the expansion of gases in the second duct or the second chamber exerts a pressure on the wearer.

15. The G-suit according to claim 14, wherein the pressure acting on the wearer is sufficient to prevent nitrogen and steam bubble formation, as well as other altitude sickness symptoms.
